(19) United States
(12) Patent Application Publication
(10) Pub. No.: US 2026/0291928 A1
(43) Pub. Date: Sep. 24, 2026

(54) MULTI-DIMENSIONAL USER COHORT CLASSIFICATION, EXPANSION, AND CROSS-PLATFORM ADAPTATION

(71) Applicant: SocialTrendly, Inc. d/b/a Blackbird.AI, Rochester, NY (US)

(72) Inventors: Naushad UzZaman, Bellmore, NY (US); Grace Lee, Rochester, NY (US); Paul Burkard, Kure Beach, NC (US)

(73) Assignee: SocialTrendly, Inc. d/b/a Blackbird.AI, Rochester, NY (US)

(21) Appl. No.: 19/574,009

(22) Filed: Mar. 20, 2026

Related U.S. Application Data
(60) Provisional application No. 63/775,547, filed on Mar. 21, 2025.

(51) Int. Cl. H04L 9/40

(52) U.S. Cl. CPC H04L 63/08

(57) ABSTRACT

Disclosed embodiments may provide techniques for identifying and expanding cohorts across digital-communication platforms. A computer-implemented method can include determining a set of primary accounts from a plurality of accounts associated with a digital communication platform. In some instances, a primary account of the set of primary accounts is determined to generate content that conforms to a set of cohort attributes. The computer-implemented method can also include, for each primary account of the set of primary accounts: (i) identifying one or more secondary accounts that performed one or more operations that interact with the content generated by the primary account; and (ii) associating the one or more secondary accounts with the primary account to generate a cohort of the set of cohorts. The computer-implemented method can also include refining each of the set of cohorts by validating the one or more secondary accounts associated with a corresponding primary account.

### CROSS-REFERENCES TO RELATED APPLICATIONS

This application claims benefit to U.S. Provisional Application No. 63/775,547, filed Mar. 21, 2025 and entitled “MULTI-DIMENSIONAL USER COHORT CLASSIFICATION, EXPANSION, AND CROSS-PLATFORM ADAPTATION”, which is hereby incorporated by reference, in its entirety and for all purposes.

### FIELD

The present disclosure relates generally to analyze user-activity patterns that correspond to misinformation threats in digital-communication platforms. In one example, the systems and methods described herein may be used to identify and expand cohorts across different digital-communication platforms to identify specific users or bots that disseminate misinformation.

### SUMMARY

Disclosed embodiments may provide techniques for identifying and expanding cohorts across digital-communication platforms. A computer-implemented method can include accessing communication data from the digital-communication platform, in which the communication data identifies a plurality of accounts. The computer-implemented method can also include determining a set of primary accounts from the plurality of accounts. In some instances, a primary account of the set of primary accounts is determined to generate content that conforms to a set of cohort attributes, and the set of cohort attributes are associated with one or more characteristics of a particular cohort of the set of cohorts. The computer-implemented method can also include, for each primary account of the set of primary accounts: (i) identifying one or more secondary accounts that performed one or more operations that interact with the content generated by the primary account; and (ii) associating the one or more secondary accounts with the primary account to generate a cohort of the set of cohorts. The computer-implemented method can also include refining each of the set of cohorts by validating the one or more secondary accounts associated with a corresponding primary account.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates an example schematic diagram of a computing environment for identifying and expending cohorts associated with digital-communication platforms, according to some embodiments.

FIG. 2 illustrates an example schematic diagram of a process for generating a set of cohorts associated with a digital-communication platform, according to some embodiments.

FIG. 3 shows an illustrative example of a process of generating a set of cohorts associated with a digital-communication platform, in accordance with some embodiments.

FIG. 4 illustrates an example schematic diagram of a process for identifying cohorts across a plurality of digital-communication platforms, according to some embodiments.

FIG. 5 shows an illustrative example of a process of identifying cohorts across a plurality of digital-communication platforms, in accordance with some embodiments.

FIG. 6 illustrates an example schematic diagram of a process for validating a set of cohorts determined for a digital-communication platform, according to some embodiments.

FIG. 6 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present techniques provide a comprehensive framework for identifying, classifying, expanding, and transferring user cohorts within and across digital platforms. The present techniques integrate content-driven and source-driven analysis to identify coherent user groups (cohorts), designate elite “seed” users (and in some embodiments, “elite” channels or groups), and employ iterative methods—including exposure scoring—to expand initial cohorts to larger user populations. This scaling process allows the system to move from a small, well-defined elite subset to a broader, more representative cohort population on the same platform.

The present techniques further enable automated or semi-automated adaptation of established cohorts from one platform to another, utilizing textual markers, network features, large language models (LLMs), and knowledge distillation techniques to replicate cohesive group definitions with minimal manual intervention. This cross-platform adaptation minimizes manual annotation efforts, ensures consistency of cohort definitions, and provides a scalable approach to track narrative-driven communities across multiple social media ecosystems. In some instances, the present techniques can be adapted to non-social media domains (e.g., e-commerce or forums), using only partial steps such as marker-based querying.

While the present techniques highlight usage for risk mitigation (e.g., spotting state-sponsored campaigns or misinformation networks), they also support the identification of positive opportunities such as finding brand ambassadors, uncovering new market segments, or guiding product improvements. By revealing influential, pro-brand, or trendsetting user groups, this system allows stakeholders to channel resources or outreach more effectively toward high-impact or high-potential audiences.

The present techniques provide various advantages over existing techniques. Existing techniques typically address only content-driven analysis (e.g., keyword-based classification) or influencer detection without dynamic cohort expansion or cross-platform propagation. Additionally, existing techniques rarely consider entire channels or groups as “elite”. The present techniques overcome these challenges by integrating multiple dimensions (content, source, iterative expansion, and cross-platform adaptation) and recognizing that channels can serve as core anchors or “elite” entities. Existing solutions generally require full manual re-labeling of cohorts in new platforms. In contrast, this invention introduces semi-automated processes that significantly reduce manual overhead and ensure consistent narrative frameworks across different ecosystems.

Moreover, unlike conventional approaches that often focus solely on identifying threats or “bad actors,” the present techniques also provide the ability to reveal high-value communities (e.g., supporters, potential brand ambassadors, or new product audiences). By clarifying that the invention's protection extends to modules and sub-processes, the disclosure ensures that using any key inventive step—like exposure scoring for cohort expansion, LLM-assisted annotations for platform adaptation, or just the elite identification process—remains within the scope of the invention.

The present techniques facilitate richer intelligence by integrating both content-driven and source-driven user attributes. They enable the identification of hidden drivers and coherent user segments that shape narrative flow, providing deeper insights into the mechanisms behind information dissemination. Entire channels or websites can be designated as “elite” exemplars, which is particularly useful on platforms like Telegram or Reddit, where channels significantly influence narratives. In addition, the present techniques automate the scaling process from a small set of elite exemplars to a larger user cohort, reducing the need for manual intervention. They also extend established cohort definitions to new platforms with minimal manual labeling, ensuring consistency across different social media ecosystems. This consistency allows for longitudinal and cross-platform comparisons, making it easier to track evolving influence patterns over time.

The modular and adaptable nature of the present techniques ensures that even implementing a single novel step, such as exposure scoring or LLM-based annotation, provides value within the broader framework. Additionally, they support the discovery of positive opportunities by identifying communities aligned with specific brands, interests, or emerging trends, unlocking potential for growth and strategic collaborations. Furthermore, these methods apply not only to traditional user structures but also to non-traditional ones, including broadcast-only channels, subreddits, and group chats, broadening their applicability across diverse online environments.

This system enhances the understanding of information provenance and dissemination pathways, offering improved narrative analysis by identifying both the content and the individuals behind it. Its scalable cross-platform analysis allows for the rapid application of known cohort insights to emerging platforms. Additionally, it provides deep insights into narrative drivers, influence spread, and misinformation networks. By identifying opportunity-centric user segments, the system supports targeted campaigns, brand advocacy, and market entry strategies. It serves as a powerful tool for misinformation detection, influence operation analysis, brand reputation management, and thematic research, with the adaptability to evolving platforms and changing data conditions.

The breadth of applications extends across multiple domains. In intelligence and security, it aids in identifying state-sponsored influence networks, extremist groups, and malicious botnets. For brand management, it detects coordinated campaigns against a brand while also uncovering supportive communities across various social platforms. In public health, it enables the tracking of anti-vaccine communities as they migrate to new platforms and identifies pro-science or pro-health communities for targeted interventions. Academic researchers can leverage this system for comparative studies of platform-specific communities and narrative evolutions. Additionally, it facilitates audience segmentation for targeted advertising and communication strategies.

The value proposition lies in its ability to deliver a comprehensive, multi-layered understanding of influence dynamics. It offers a balanced approach that not only detects risks but also capitalizes on opportunities through deeper cohort insights. By streamlining operational processes, the system reduces the costs associated with manual annotation and retagging while ensuring consistency in cohort identification and analysis across platforms. Its modular design further allows for partial adoption of components based on specific needs.

### I. Techniques for Identifying and Expanding Cohorts Within Digital Communication Platforms

The present techniques provide a unified system and methodology for identifying and scaling user cohorts from a small “elite” seed set to broader groups. This process leverages both content and source signals to create a multi-layered characterization of user behavior and network influence. The term “elite” may refer to an individual user, a group of users, or an entire channel, such as a Telegram channel or subreddit, that strongly exhibits the defining characteristics of the cohort. Additionally, these techniques facilitate the transfer of established cohort definitions to new platforms by utilizing cross-domain textual markers and LLM-based adaptation, enabling rapid discovery and labeling of analogous user cohorts with minimal manual intervention. In some cases, entire channels or sets of channels can serve as elite entities rather than individual users. As a result, the present techniques can be used to extend channel-level classification to other broadcast platforms such as YouTube or streaming services.

The present techniques support both risk mitigation, such as detecting misinformation, and opportunity identification, such as finding emerging markets or brand ambassadors. Within a single platform, the system classifies posts and users into content-driven cohorts based on textual analysis while also identifying source-driven cohorts by analyzing user affiliations, engagements, memberships in specific channels, and network structures. Elite users or channels are pinpointed based on their strong representation of cohort characteristics. Cohorts are then expanded through exposure scoring, network-based propagation, and iterative validation. By categorizing and understanding the influence, sentiment, and strategic potential of these users or channels, stakeholders can identify both risks and opportunities.

For cross-platform adaptation, the system extracts textual markers and features that define cohorts on the home platform and applies them to filter and query data on a new platform, narrowing the search space. LLM-based or human annotations are applied to sampled data from the new platform to align it with known cohorts. Machine learning classifiers, such as transformer-based models, are trained on the annotated samples to distill knowledge and scale cohort identification across full datasets. Alternatively, an LLM-based classifier can be directly used instead of traditional ML models. Elite users or channels are identified within the new platform environment, and cohort labels are refined to ensure consistency with the home platform's definitions. This process uncovers high-potential or high-risk communities in each new environment, providing actionable insights for strategic engagement and proactive response.

Each process can be implemented to be independent from other cohort-identification processes. As a result, the present techniques can ensure coverage even with partial implementations. For example, using only LLM annotation for cross-domain adaptation or focusing solely on elite identification for user classification remains within the framework of the cohort-identification system, maintaining its adaptability to different analytical needs.

In some implementations, the present techniques are deployed within cloud-based data lakes, machine learning pipelines, and LLM integration for annotation and iterative refinement. User interconnections, including engagements, sharing patterns, following relationships, channel memberships, and forwarding behaviors, can be represented using graph or network models. Interactive dashboards or well-documented APIs are provided for intelligence analysts to access, refine, and interpret results efficiently.

The system also supports flexible integration with external analytics, APIs, and evolving data pipelines. Machine learning models, embeddings, and LLM-based annotation and refinement processes can be incorporated alongside human annotation and review where necessary. To maintain long-term performance, periodic model retraining and dynamic threshold adjustments are included as part of the implementation, ensuring adaptability to changing data conditions.

### A. Example Computing Environment

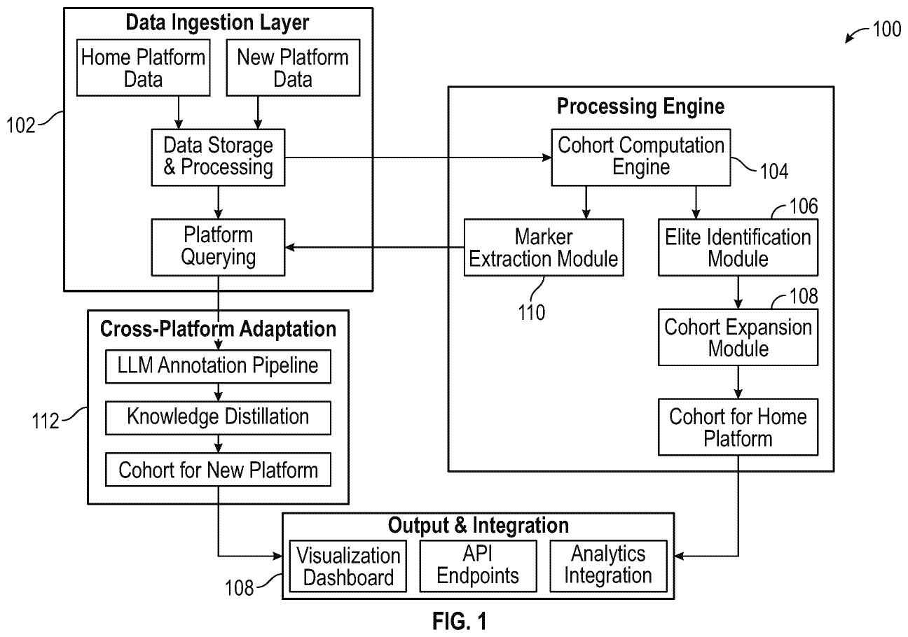

FIG. 1 illustrates an example schematic diagram 100 of a computing environment for identifying and expanding cohorts associated with digital-communication platforms, according to some embodiments. As shown in FIG. 1, the cohort-identification system includes various modules, each contributing to the overall process of cohort identification, expansion, and cross-platform adaptation. For example, a data ingestion layer 102 can be configured to collect communication data from both the home platform and new platforms, ensuring a comprehensive dataset for analysis. The communication data can be associated with a plurality of accounts (e.g., users, channels). In some instances, the communication data includes account profiles associated with the plurality of accounts, a plurality of messages generated by the plurality of accounts, and network metadata associated with the digital-communication platform. The communication data can include account profiles that correspond to structured representations of user information. The account profiles may include identifiers, preferences, or activity logs associated with each account of the digital-communication platform. In another example, the communication data can include a plurality of messages associated with textual, audio, or multimedia communications generated by the accounts. The plurality of messages can thus capture the content exchanged on the digital-communication platform. In yet another example, the communication data can include network metadata, which includes contextual information related to the digital-communication platform, such as timestamps, IP addresses, device identifiers, or routing data.

In some instances, the network metadata can be used to analyze message transmission patterns and network behaviors of the accounts of the digital-communication platform. The communication data can thus be used to discover user interactions and communication dynamics within the digital-communication platform, thereby facilitating identification of different cohorts.

The communication data identifies a plurality of accounts associated with the digital-communication platform. The plurality of accounts can represent individual users, channels, groups, or automated entities participating in interactions in the digital-communication platform. In some instances, each account can be associated with unique identifiers, such as usernames, email addresses, or device IDs. Additionally or alternatively, the communication data may capture account-related metadata, including registration details, activity history, and interaction patterns.

The communication data within the cohort-identification system can be stored using various types of storage architecture that facilitates efficient retrieval and processing. For example, a combination of relational and NoSQL databases can be utilized to store interaction records, content metadata, and cohort associations. A relational database such as PostgreSQL or MySQL can manage structured data, including user IDs, timestamps, message metadata, and interaction types like likes, shares, or replies. Meanwhile, a NoSQL database such as MongoDB or Cassandra can handle semi-structured or unstructured communication data, including raw message content, multimedia, and engagement logs. To optimize data retrieval, indexing can be applied to frequently queried fields such as account IDs, timestamps, and cohort attributes. For processing, both batch and real-time stream processing methods can be implemented.

The cohort communication engine 104 can be configured to classify users and content based on both content-driven and source-driven attributes, enabling a nuanced understanding of user group dynamics. Initially, the cohort communication engine 104 can analyze the communication data to classify a set of primary accounts (alternatively referred to as “influential users” or “elite users”) from the plurality of accounts. As an illustrative example, an elite-user identification module 106 can be configured to detect highly influential users or channels within a cohort and expand the identified group using iterative methods such as exposure scoring and network-based propagation. In some instances, the cohort communication engine 104 can classify a user, a user group (e.g., sub-Reddit), or channel (e.g., Discord channels) as a primary account based on its generated content that conforms to a set of cohort attributes. The set of cohort attributes is associated with one or more characteristics of a particular cohort of the set of cohorts. Stated differently, the set of cohort attributes correspond to characteristics that distinguishes the particular cohort from other cohorts of the set. In some instances, the set of cohort attributes is generated by processing the communication data using a machine-learning model.

The set of cohort attributes can be used to identify potential risks or positive characteristics within a given cohort. For example, these attributes may help detect the presence of misinformation or network threats that are prevalent among members of the cohort, allowing for proactive measures to mitigate security risks and ensure information integrity. The mitigation measures can include deactivating the accounts associated with the cohort, dropping or otherwise blocking network packets transmitted from the IP addresses of the accounts of the cohort, or deleting content generated by the accounts of the cohort. In another example, cohort attributes can also be used to identify positive or constructive aspects about the corresponding cohort, such as a group's participation in social initiatives (e.g., hunger) or its efforts in advocating for safe and secure programming practices (e.g., responsible AI). For the positive cohorts, other types of operations can be performed by the digital communication platform such as widely distributing the content generated by the corresponding cohort across different communication channels. By capturing harmful and beneficial traits, the cohort framework enhances understanding of a cohort's influence, behaviors, and interactions within digital communication platform.

Other techniques can be used to identify the primary accounts. For example, the primary account can be determined further based on: (i) a number of accounts that interacted with the primary account exceeding a threshold value; and (ii) a number of messages corresponding to the content. For example, the primary account can be determined based on the number of distinct accounts that have engaged with the primary account, such as through direct communication, content exchanges, or other forms of interaction.

Once the primary accounts are identified, a cohort expansion module 108 can identify, for each primary account, one or more secondary accounts. The secondary accounts can correspond to accounts that performed one or more operations interacting with the content generated by the primary account. The interactions may include a range of user activities, including but not limited to viewing, responding to, sharing, or otherwise engaging with the content in a manner that establishes a connection between the one or more secondary accounts and the corresponding primary account.

In some instances, to identify the secondary accounts, the cohort expansion module 108 can generate an exposure score for an account of the plurality of accounts. The exposure score represents an estimated degree of interactions that conform to the set of cohort attributes. The exposure score may be computed based on various engagement metrics associated with the secondary accounts, including the frequency or type of operations performed by the secondary account in relation to the content of the primary account. In some instances, the exposure score is generated by processing a portion of the communication data using another machine-learning model, in which the portion of the communication data is associated with the secondary account. If the cohort-identification system can determine that the exposure score exceeds a threshold value, the cohort-identification system can identify the account as a secondary account of the one or more secondary accounts.

The Marker Extraction and Cross-Platform Querying Module 110 extracts textual markers from existing cohorts and applies them to new platforms to locate similar user groups, facilitating seamless cross-domain adaptation. For example, feature extraction from the cohort data of a source digital-communication platform can be conducted using NLP techniques, including TF-IDF vectorization to identify relevant keywords and sentiment analysis to determine the characteristics of user interactions associated with the source cohort. The extracted markers and features can be used as marker-based queries on a target digital-communication platform to locate filtered communication data that includes relevant posts or users.

In some instances, the LLM-assisted annotation and knowledge distillation pipeline 112 enhances data labeling by using large language models (LLMs) to annotate and refine cohort definitions. It also employs knowledge distillation techniques to scale annotated samples into full datasets, improving classification accuracy. For example, sampled filtered communication data is annotated using LLM prompts aligned with known cohorts. The annotated communication data can then be used as training data for training a classification model to identify target cohorts within the target digital-communication platform. For example, an artificial neural network can be trained on the LLM-annotated subset and scaled to the remaining portions of the communication data. Finally, the output layer 114 provides visualization and integration capabilities, enabling stakeholders to interact with results through dashboards, APIs, or external analytics tools.

Each of these modules can function independently or in combination with others, with each implementation embodying core aspects of the present techniques.

### B. Generating Cohorts Within a Digital Communication Platform

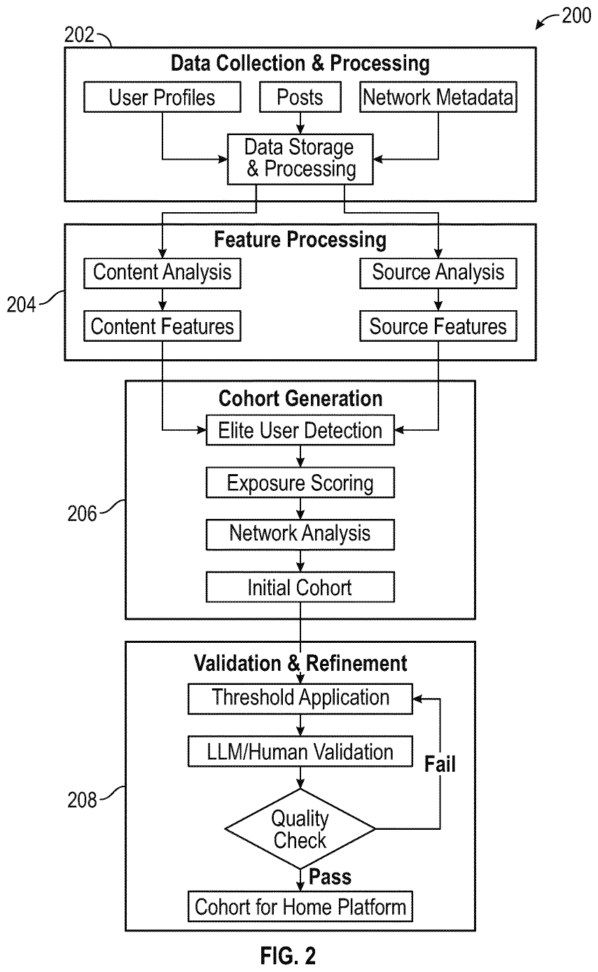

FIG. 2 illustrates an example schematic diagram of a process 200 for generating a set of cohorts associated with a digital-communication platform, according to some embodiments. In FIG. 2, the present techniques begin with data collection and marker generation, where user profiles, posts, and network metadata are gathered from a target platform (block 202). For example, the cohort-identification system accesses communication data (e.g., user profiles, posts, and network metadata) from the target digital-communication platform. In some instances, the communication data includes account profiles that correspond to structured representations of user information. The account profiles may include identifiers, preferences, or activity logs associated with each account of the digital-communication platform.

The communication data can include a plurality of messages associated with textual, audio, or multimedia communications generated by the accounts. The plurality of messages can thus capture the content exchanged on the digital-communication platform. The communication data can also include network metadata, which includes contextual information related to the digital-communication platform, such as timestamps, IP addresses, device identifiers, or routing data. The network metadata can be used to analyze message transmission patterns and network behaviors of the accounts of the digital-communication platform.

The communication data identifies a plurality of accounts associated with the digital-communication platform. The plurality of accounts can represent individual users, channels, groups, or automated entities participating in interactions in the digital-communication platform. In some instances, each account can be associated with unique identifiers, such as usernames, email addresses, or device IDs. Additionally or alternatively, the communication data may capture account-related metadata, including registration details, activity history, and interaction patterns.

The communication data can be used to discover markers or features associated with user interactions and communication dynamics within the digital-communication platform, thereby facilitating identification of different cohorts. In some instances, a large language model (LLM) can be trained to generate textual markers for different cohorts by suggesting keywords, phrases, or topics indicative of specific groups (e.g., “Pro-Russia,” “Pro-China,” “Anti-Vaxxer”) based on known or open-source intelligence (OSINT) definitions. Posts containing these markers are continuously collected, filtered by criteria such as follower count, and stored for further analysis. Alternatively, the above filtering step can be bypassed, and cohort identification can begin directly with manually-identified accounts and channels. In some instances, the LLM-based marker generation can be applied iteratively, first identifying a narrow set of keywords or phrases, then expanding that set as the system uncovers new terminology or usage patterns via analyzing the top 20,000 accounts.

In some instances, NLP or LLM-based classifiers can be applied to label users or channels based on content analysis (block 204). The user-labeling operation can be used to facilitate cohort identification. For structured text, tokenization, stemming, and stop-word removal can be applied to normalize the communication data before classification. For digital-communication platforms supporting multimedia content (e.g., YouTube or TikTok), descriptions or transcripts of top videos from influential accounts can be extracted for further evaluation. In some instances, automatic speech recognition (ASR) models can be used to generate transcripts from the top videos. The transcripts, along with video descriptions, can then be processed using transformer-based content-analysis machine-learning models (e.g., BERT, GPT), to extract key topics, sentiment, or intent. To improve accuracy, model predictions can be continuously refined using feedback loops, incorporating human validation or reinforcement learning techniques. By automating content-based user labeling, the cohort formation can be enhanced using the content-analysis machine-learning models, enabling more precise grouping of accounts based on their interaction and content characteristics.

At block 206, elite users or channels—those that strongly represent certain cohort attributes—are identified using LLM-based content scoring, engagement metrics, network structure, and OSINT intelligence. For example, based on the extracted markers and features, the cohort-identification system determines a set of primary accounts from the plurality of accounts. A primary account of the set of primary accounts is determined to generate content that conforms to a set of cohort attributes. The set of cohort attributes is associated with one or more characteristics of a particular cohort of the set of cohorts. As used herein, the term “cohort” refers to a one or more users who share common characteristics or interaction patterns within the digital-communication platform at a specific timeframe. Stated differently, the set of cohort attributes correspond to characteristics that distinguishes the particular cohort from other cohorts of the set. In some instances, the primary account can be determined further based on: (i) a number of accounts that interacted with the primary account exceeding a threshold value; and (ii) a number of messages corresponding to the content. For example, the primary account can be determined based on the number of distinct accounts that have engaged with the primary account, such as through direct communication, content exchanges, or other forms of interaction. In some instances, rather than focusing on follower count, the system may rank users by their volume of posts or engagement in channels known to represent certain cohorts.

The set of cohort attributes can be used to identify potential risks or positive characteristics within a given cohort. For example, these attributes may help detect the presence of misinformation or network threats that are prevalent among members of the cohort, allowing for proactive measures to mitigate security risks and ensure information integrity. The mitigation measures can include deactivating the accounts associated with the cohort, dropping or otherwise blocking network packets transmitted from the IP addresses of the accounts of the cohort, or deleting content generated by the accounts of the cohort. In another example, cohort attributes can also be used to identify positive or constructive aspects about the corresponding cohort, such as a group's participation in social initiatives (e.g., hunger) or its efforts in advocating for safe and secure programming practices (e.g., responsible AI). By capturing harmful and beneficial traits, the cohort framework enhances understanding of a cohort's influence, behaviors, and interactions within digital communication platform.

In some instances, the set of cohort attributes is generated by processing the communication data using a cohort-identification machine-learning model. The cohort-identification machine-learning model can be a natural-language processing model trained using the previous communication data and corresponding cohort attributes generated based on the previous communication data. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods. As an illustrative example, a large language model (LLM) or human can be used to extract cohort-specific attributes such as key phrases, hashtags, or semantic cues that characterize the cohort.

In some instances, to refine cohort identification, LLM-based rating and exposure calculation techniques are employed. An LLM such as GPT can assign a relevance score (e.g., 0 to 10) to each account or channel, indicating how strongly it aligns with the set of cohort attributes of the particular cohort (e.g., “Pro-Russia” vs. “Left Wing”). The relevance score facilitates filter high-quality data.

In some instances, the machine-learning model is a transformer model (e.g., a large-language model (LLM)) obtained from a models database. In some instances, the machine-learning model is trained using self-supervised learning based on a large corpus of text data, such that the machine-learning model can generate the cohort attributes. In addition to training the model, various prompts can be used for prompt engineering of the machine-learning model for generating the cohort attributes. Examples of the content machine-learning model can include, but are not limited to, BERT model, Claude LLM, Falcon 40B, Ernie, GPT-3, GPT-3.5, GPT 4, Lamda, and Llama.

An illustrative example process of training the transformer model (e.g., a GPT model) is as follows. For the training dataset (e.g., the previous input data and corresponding cohort attributes), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

In some instances, the cohort-identification system can construct one or more prompts that can be submitted with the communication data to enhance and increase the accuracy of the cohort attributes. As used herein, the term “prompt” can refer to as an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used iteratively refine the prompt P to maximize O(P, R), to facilitate the model to consistently produce accurate, relevant, and contextually appropriate outputs (e.g., the cohort attributes). For example, the optimal prompt P* can be determine based on maximizing the objective function O:

$${P}^{*} = arg max O ( P , ( P ) ) \qquad Equation ( 1 )$$

Through the iterative refinement process, prompt engineering enhances the corresponding model's performance across various natural language processing tasks, such as generating the cohort attributes that are contextually relevant to the communication data.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

The cohort-identification system can apply the trained and fine-tuned machine-learning model to the communication data to generate the cohort attributes. To begin the deployment process, the cohort-identification system can tokenize the merged data input a sequence of text tokens. For example, the merged data can be tokenized to provide the following sequence: [“You”, “are”, “an”, “assistant”, “tasked”, . . . ]. In some instances, the machine-learning model uses Byte Pair Encoding (BPE) techniques to further split a single token (e.g., “in”, “sufficient”).

The cohort-identification system can assign each token with a particular index value in the vocabulary (e.g., “assistant”=E[5]). Then, the cohort-identification system can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token tᵢ based on using the index value looking at a corresponding row of embedding matrix E.

$$E : {e}_{i} = E [ {t}_{i} ] \qquad Equation ( 2 )$$

The cohort-identification system can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the cohort-identification system can then determine a contextual representation for each position-encoded vector of the matrix X. In particular, for each position-encoded vector, the cohort-identification system can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

$$( Q , K , V ) = softmax ( ( Q {K}^{T} ) / √ ( {d}_{k} ) ) V \qquad Equation ( 3 )$$

The (QK^{T})/√(dₖ) can be used to compute the raw attention scores, in which dₖ is the dimensionality of the key vectors. Then, the softmax function is applied to the raw attention score to normalize it into a probability distribution. The cohort-identification system can apply the attention score to a V vector of the corresponding set of Q, K, V vectors, such that the weighted Q, K, V vectors can be used as the contextual representation of the position-encoded vector of matrix X. In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the merged data.

The cohort-identification system can then apply the machine-learning model to the set of contextual representations to generate the cohort attributes. In particular, the machine-learning model can process the set of contextual representations to predict each token of the output, in which the output tokens can correspond to the cohort attributes.

Follower and member analysis can then be conducted to iteratively expand the cohort. The followers, subscribers, or members of highly rated accounts are analyzed to determine whether they engage with similar content or channels. For example, the cohort-identification system identifies, for each primary account of the set of primary accounts, one or more secondary accounts that performed one or more operations interacting with the content generated by the primary account. The interactions may include a range of user activities, including but not limited to viewing, responding to, sharing, or otherwise engaging with the content in a manner that establishes a connection between the one or more secondary accounts and the corresponding primary account.

In some instances, to identify the secondary accounts, the cohort-identification system can generate an exposure score for an account of the plurality of accounts. The exposure score represents an estimated degree of interactions that conform to the set of cohort attributes. The exposure score may be computed based on various engagement metrics associated with the secondary accounts, including the frequency or type of operations performed by the secondary account in relation to the content of the primary account. In some instances, the exposure score is generated by processing a portion of the communication data using a cohort-expansion machine-learning model, in which the portion of the communication data is associated with the secondary account. If the cohort-identification system can determine that the exposure score exceeds a threshold value, the cohort-identification system can identify the account as a secondary account of the one or more secondary accounts.

At step 308, the cohort-identification system associates, for each primary account of the set of primary accounts, the one or more secondary accounts with the primary account to generate a cohort of the set of cohorts. For example, the cohort-identification system can store the associations in a graph-based data structure, in which primary accounts are represented as nodes that are linked to the corresponding secondary accounts. In some instances, the cohort-identification system can apply clustering algorithms (e.g., hierarchical clustering, density-based clustering) to associate the primary and secondary accounts based on their exposure scores or interaction patterns. The clustering algorithm facilitates the primary and secondary accounts both alight to the particular cohort. In another example, rule-based algorithms can be used to dynamically update account associations as new interaction data is processed, thereby allowing the cohort-identification system to adapt to changing user-engagement patterns while maintaining alignment with the set of cohort attributes.

During the validation phase (block 208), thresholds are refined iteratively, incorporating both human and LLM-based validation to expand the cohort from the elite users. Additional user-activity signals, such as membership overlaps, forwarding patterns (in Telegram), and cross-posting frequency, are integrated to validate and adjust cohort labels, ensuring a more accurate and scalable classification process. For example, to validate the one or more secondary accounts, the cohort-identification system can determine whether the one or more secondary accounts generated content that conforms to the set of cohort attributes. In some instances, the cohort-identification system can apply classification models or rule-based filters to determine whether the content characteristics conform to the set of cohort attributes associated with the particular cohort. The cohort-identification system may utilize natural language processing (NLP) techniques, keyword analysis, or metadata tagging to analyze textual content, while image or video recognition models can be implemented for multimedia-content validation. Additionally or alternatively, statistical techniques (e.g., cosine similarity) can be used to determine the degree of alignment between the secondary account's content and the set of cohort attributes. If the content generated by the secondary account does not meet the validation criteria, the cohort-identification system can dynamically update the cohort associations by reassigning or excluding the secondary account. The above validation process ensures that each cohort that includes the primary and second accounts remains representative of its defined attributes while adapting to evolving interaction patterns

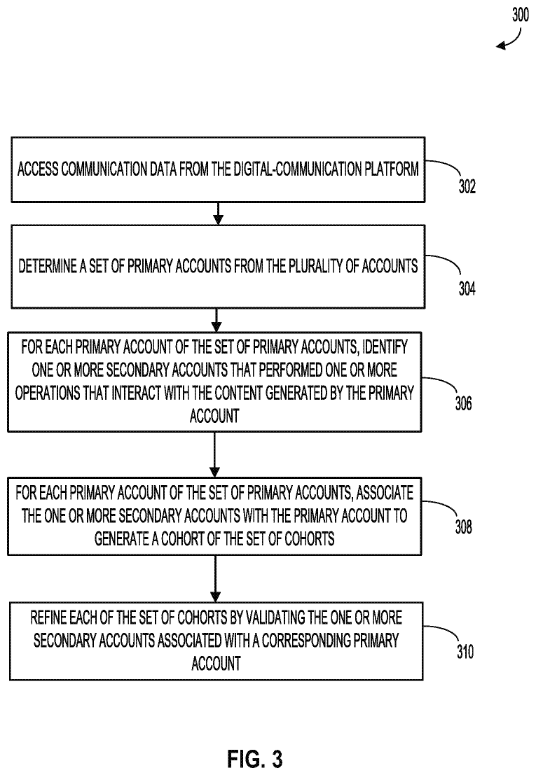

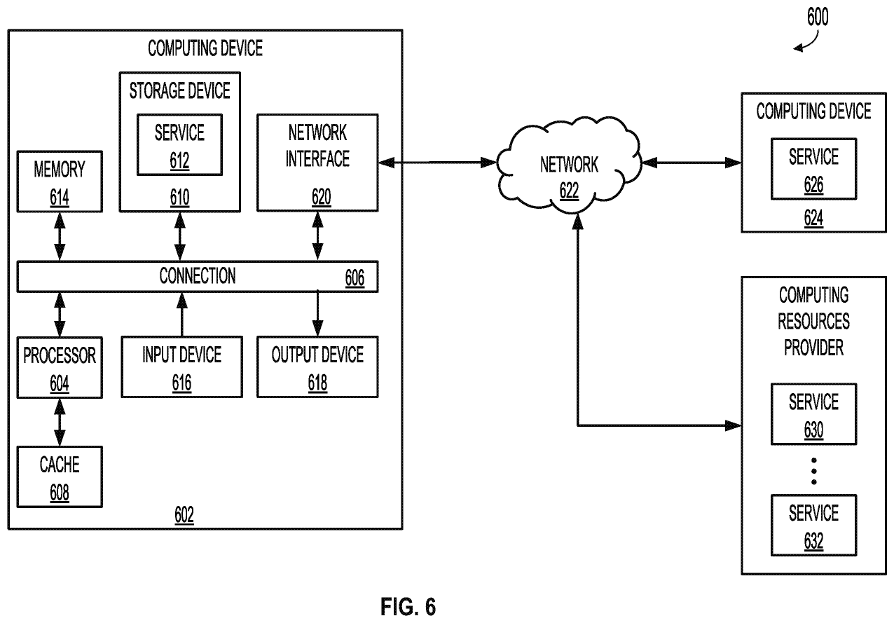

FIG. 3 shows an illustrative example of a process 300 of generating a set of cohorts associated with a digital-communication platform, in accordance with some embodiments. For illustrative purposes, the process 300 is described with reference to the components illustrated in FIGS. 1-2, though other implementations are possible. For example, the program code for the cohort-identification system of FIG. 1, is executed by one or more processing devices to cause a server system (e.g., the computing device 602 of FIG. 6) to perform one or more operations described herein.

At step 302, the cohort-identification system accesses communication data from the digital-communication platform. In some instances, the communication data includes account profiles associated with the plurality of accounts, a plurality of messages generated by the plurality of accounts, and network metadata associated with the digital-communication platform. For example, the communication data can include account profiles that correspond to structured representations of user information. The account profiles may include identifiers, preferences, or activity logs associated with each account of the digital-communication platform. In another example, the communication data can include a plurality of messages associated with textual, audio, or multimedia communications generated by the accounts. The plurality of messages can thus capture the content exchanged on the digital-communication platform. In yet another example, the communication data can include network metadata, which includes contextual information related to the digital-communication platform, such as timestamps, IP addresses, device identifiers, or routing data. The network metadata can be used to analyze message transmission patterns and network behaviors of the accounts of the digital-communication platform. The communication data can thus be used to discover user interactions and communication dynamics within the digital-communication platform, thereby facilitate identification of different cohorts.

The communication data identifies a plurality of accounts associated with the digital-communication platform. The plurality of accounts can represent individual users, channels, groups, or automated entities participating in interactions in the digital-communication platform. In some instances, each account can be associated with unique identifiers, such as usernames, email addresses, or device IDs. Additionally or alternatively, the communication data may capture account-related metadata, including registration details, activity history, and interaction patterns.

At step 304, the cohort-identification system determines a set of primary accounts from the plurality of accounts. A primary account of the set of primary accounts is determined to generate content that conforms to a set of cohort attributes. Stated differently, the cohort-identification system can classify a user, a user group (e.g., sub-Reddit), or channel (e.g., Discord channels) as a primary account based on its generated content that conforms to the set of cohort attributes. The set of cohort attributes is associated with one or more characteristics of a particular cohort of the set of cohorts. Stated differently, the set of cohort attributes correspond to characteristics that distinguishes the particular cohort from other cohorts of the set. In some instances, the primary account can be determined further based on: (i) a number of accounts that interacted with the primary account exceeding a threshold value; and (ii) a number of messages corresponding to the content. For example, the primary account can be determined based on the number of distinct accounts that have engaged with the primary account, such as through direct communication, content exchanges, or other forms of interaction.

The set of cohort attributes can be used to identify potential risks or positive characteristics within a given cohort. For example, these attributes may help detect the presence of misinformation or network threats that are prevalent among members of the cohort, allowing for proactive measures to mitigate security risks and ensure information integrity. The mitigation measures can include deactivating the accounts associated with the cohort, dropping or otherwise blocking network packets transmitted from the IP addresses of the accounts of the cohort, or deleting content generated by the accounts of the cohort. In another example, cohort attributes can also be used to identify positive or constructive aspects about the corresponding cohort, such as a group's participation in social initiatives (e.g., hunger) or its efforts in advocating for safe and secure programming practices (e.g., responsible AI). By capturing harmful and beneficial traits, the cohort framework enhances understanding of a cohort's influence, behaviors, and interactions within digital communication platform.

In some instances, the set of cohort attributes is generated by processing the communication data using a machine-learning model. The machine-learning model can be a natural-language processing model trained using the previous communication data and corresponding cohort attributes generated based on the previous communication data. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

At step 306, the cohort-identification system identifies, for each primary account of the set of primary accounts, one or more secondary accounts that performed one or more operations interacting with the content generated by the primary account. The interactions may include a range of user activities, including but not limited to viewing, responding to, sharing, or otherwise engaging with the content in a manner that establishes a connection between the one or more secondary accounts and the corresponding primary account.

In some instances, to identify the secondary accounts, the cohort-identification system can generate an exposure score for an account of the plurality of accounts. The exposure score represents an estimated degree of interactions that conform to the set of cohort attributes. The exposure score may be computed based on various engagement metrics associated with the secondary accounts, including the frequency or type of operations performed by the secondary account in relation to the content of the primary account. In some instances, the exposure score is generated by processing a portion of the communication data using another machine-learning model, in which the portion of the communication data is associated with the secondary account. If the cohort-identification system can determine that the exposure score exceeds a threshold value, the cohort-identification system can identify the account as a secondary account of the one or more secondary accounts.

At step 308, the cohort-identification system associates, for each primary account of the set of primary accounts, the one or more secondary accounts with the primary account to generate a cohort of the set of cohorts. For example, the cohort-identification system can store the associations in a graph-based data structure, in which primary accounts are represented as nodes that are linked to the corresponding secondary accounts. In some instances, the cohort-identification system can apply clustering algorithms (e.g., hierarchical clustering, density-based clustering) to associate the primary and secondary accounts based on their exposure scores or interaction patterns. The clustering algorithm facilitates the primary and secondary accounts both alight to the particular cohort. In another example, rule-based algorithms can be used to dynamically update account associations as new interaction data is processed, thereby allowing the cohort-identification system to adapt to changing user-engagement patterns while maintaining alignment with the set of cohort attributes.

At step 310, the cohort-identification system refines each of the set of cohorts by validating the one or more secondary accounts associated with a corresponding primary account. For example, to validate the one or more secondary accounts, the cohort-identification system can determine whether the one or more secondary accounts generated content that conforms to the set of cohort attributes. In some instances, the cohort-identification system can apply classification models or rule-based filters to determine whether the content characteristics conform to the set of cohort attributes associated with the particular cohort. The cohort-identification system may utilize natural language processing (NLP) techniques, keyword analysis, or metadata tagging to analyze textual content, while image or video recognition models can be implemented for multimedia-content validation. Additionally or alternatively, statistical techniques (e.g., cosine similarity) can be used to determine the degree of alignment between the secondary account's content and the set of cohort attributes. If the content generated by the secondary account does not meet the validation criteria, the cohort-identification system can dynamically update the cohort associations by reassigning or excluding the secondary account. The above validation process ensures that each cohort that includes the primary and second accounts remains representative of its defined attributes while adapting to evolving interaction patterns. Process 300 terminates thereafter.

### C. Identifying Cohorts Across a Plurality of Digital-Communication Platforms

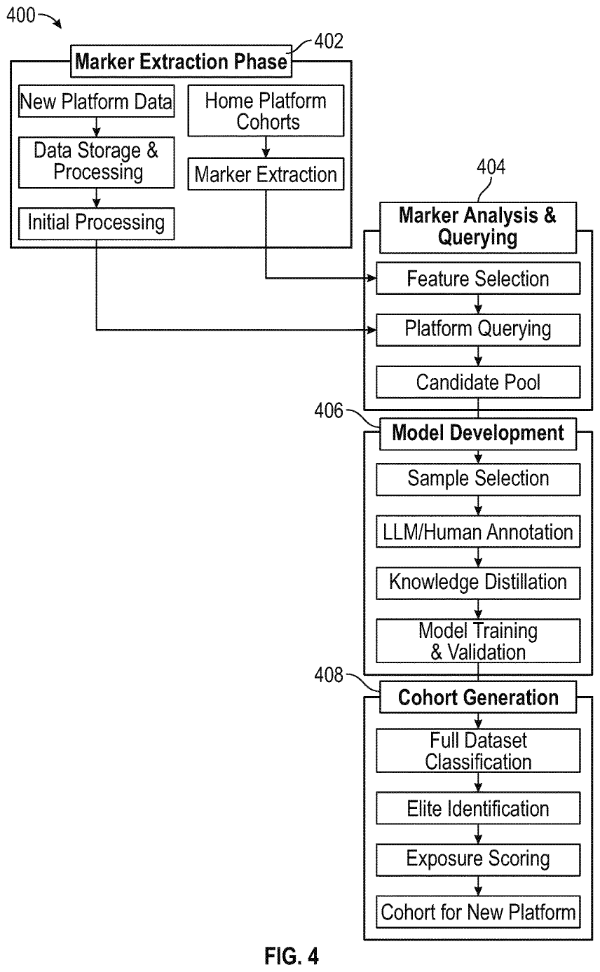

FIG. 4 illustrates an example schematic diagram 400 of a process for identifying cohorts across a plurality of digital-communication platforms, according to some embodiments.
Initially, the cohort-identification system accesses cohort data associated with a source digital-communication platform. As described above, the source cohort can include one or more users who share common characteristics or interaction patterns within the source digital-communication platform at a specific timeframe. In some instances, the cohort data includes user identifiers and cohort criteria specifying time-based attributes (e.g., sign-up date, first interaction, or first purchase), behavioral attributes (e.g., engagement frequency, content interaction, or hashtag participation), and demographic attributes (e.g., age, location, or language). The cohort data can additionally include engagement metrics over time, including retention rates, activity levels (e.g., posts, likes, shares), and conversion rates. In some instances, the engagement metrics can be timestamped to analyze behavioral patterns within the source digital-communication platform across different periods.

In some instances, the cohort-identification system generates the cohort data by: (i) receiving unstructured data identifying a set of cohort attributes associated with the source cohort and (ii) processing the unstructured data and previous communication data associated with the source digital-communication platform using a cohort-generating machine-learning model to generate the cohort data. The unstructured data items can include information that does not adhere to a predefined format or organized data model, including free-form text, multimedia files, or other non-standardized formats. Examples of unstructured data items can include social media posts, news articles, videos, audio recordings, text streams uploaded by users, and any combinations thereof.

The cohort-generating machine-learning model can be a natural-language processing model trained using the previous communication data. In some instances, the cohort-generating machine-learning model is a transformer model (e.g., a large-language model (LLM)) obtained from a models database. In some instances, the machine-learning model is trained using self-supervised learning based on a large corpus of text data, such that the machine-learning model can generate the cohort data. In addition to training the model, various prompts can be used for prompt engineering of the machine-learning model for generating the cohort attributes. Examples of the content machine-learning model can include, but are not limited to, BERT model, Claude LLM, Falcon 40B, Ernie, GPT-3, GPT-3.5, GPT 4, Lamda, and Llama.

Then, cohort markers and features can be extracted from the cohort data of the source digital-communication platform, in which distinctive textual markers are identified from established cohorts on a home platform (block 402). For example, feature extraction from the cohort data can be conducted using NLP techniques, including TF-IDF vectorization to identify relevant keywords and sentiment analysis to determine the characteristics of user interactions associated with the source cohort. In some embodiments, a large language model (LLM) or human annotator extracts cohort-specific textual markers, such as key phrases, hashtags, or semantic cues that characterize the group. Alternatively, a user may describe their desired cohort, allowing an LLM to drive downstream feature and user discovery, bootstrapping new cohorts. Even if only this step is used to inform a different classification approach on a new platform, it remains within the scope of the present techniques.

At block 404, once markers are extracted, they are used as marker-based queries on a new platform to locate filtered communication data that includes relevant posts or users. This step may also involve LLM-based or human-assisted refinement, dynamically expanding the marker set based on initial search results to enhance matching accuracy. In some instances, the cohort-identification system can generate one or more queries that include the textual markers and features and execute the one or more queries to access the filtered communication data. For example, SQL or natural-language queries can be dynamically constructed based on the textual markers to filter communication data (e.g., messages, posts, or comments containing specific terms or sentiment patterns) associated with the target digital-communication platform. The retrieved data can then be used to identify primary and secondary accounts of a cohort within the target digital-communication platform.

To further refine classification, LLM-assisted annotation and knowledge distillation techniques are employed (block 406). In particular, the cohort-identification system generates annotated communication data by annotating a portion of the filtered communication data. To annotate the portion of the filtered communication data, the cohort-identification system associates the portion of the filtered communication data with a set of annotations.

In some instances, sampled communication data is annotated using LLM prompts aligned with known cohorts, thereby generating annotated communication data. The set of annotations can be generated by processing the portion of the filtered communication data using an annotation-generating machine-learning model. For example, the annotation-generating machine-learning model can be an LLM that implements natural language processing (NLP) techniques such as entity recognition, sentiment analysis, topic modeling, or intent classification for identifying annotations for the filtered communication data. Stated differently, relevant linguistic and contextual annotations from the filtered communication data can be identified to generate the annotated communication data. Additionally or alternatively, manual annotation can be implemented to further improve accuracy of the annotations.

The annotated communication data can then be used as training data for training a classification model to identify cohorts in the target digital-communication platform. For example, an artificial neural network can be trained on the LLM-annotated subset and scaled to full data. Knowledge distillation thus utilizes embeddings or classifier outputs from the set of annotations to optimize the classification model to classify user content at scale across the new platform.

Cohort aggregation and elite identification on the target digital-communication platform consolidate post-level labels into user-level cohorts (block 408). The target cohort can include one or more users who share common characteristics or interaction patterns associated with the source cohort of the source digital-communication platform. In some instances, channel-level scoring is conducted by evaluating entire channels based on content or membership overlap with known cohorts. The system then identifies elite users, exposure scores, and iteratively refines results, mirroring processes used on the home platform. Beyond tracking negative or adversarial cohorts, these techniques also highlight potential partners, influencers, or emerging thought leaders. An LLM may be used in segmenting users with high engagement or unique content patterns, flagging potential elite users. This iterative refinement ensures consistency with previously defined cohort structures, supporting cross-platform adaptation.

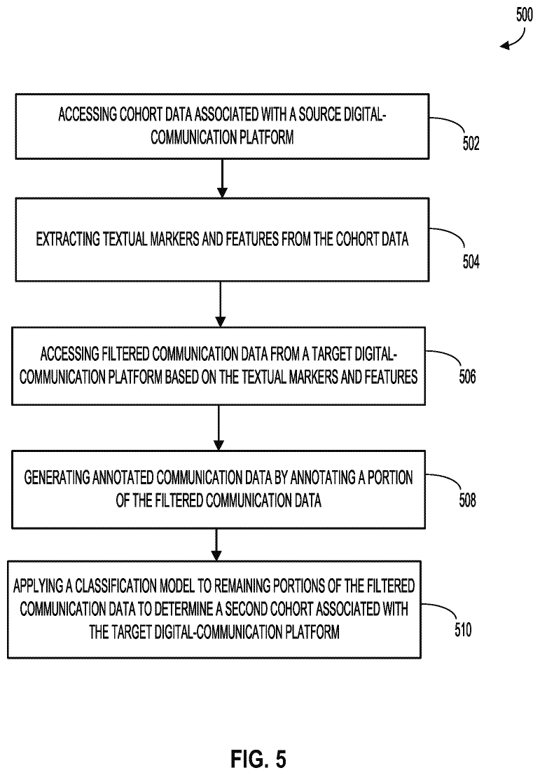

FIG. 5 shows an illustrative example of a process 500 of identifying cohorts across a plurality of digital-communication platforms, in accordance with some embodiments. For illustrative purposes, the process 500 is described with reference to the components illustrated in FIGS. 1-4, though other implementations are possible. For example, the program code for the content-identification system of FIG. 4, is executed by one or more processing devices to cause a server system (e.g., the computing device 602 of FIG. 6) to perform one or more operations described herein.

At step 502, the cohort-identification system accesses cohort data associated with a source digital-communication platform. The cohort data identifies a source cohort. As described above, the source cohort can include one or more users who share common characteristics or interaction patterns within the source digital-communication platform at a specific timeframe. In some instances, the cohort data includes user identifiers and cohort criteria specifying time-based attributes (e.g., sign-up date, first interaction, or first purchase), behavioral attributes (e.g., engagement frequency, content interaction, or hashtag participation), and demographic attributes (e.g., age, location, or language). The cohort data can additionally include engagement metrics over time, including retention rates, activity levels (e.g., posts, likes, shares), and conversion rates. In some instances, the engagement metrics can be timestamped to analyze behavioral patterns within the source digital-communication platform across different periods.

Each cohort described in the cohort data can be associated with a set of cohort attributes. The set of cohort attributes can be used to identify potential risks or positive characteristics within a given cohort. For example, these attributes may help detect the presence of misinformation or network threats that are prevalent among members of the cohort, allowing for proactive measures to mitigate security risks and ensure information integrity. In another example, cohort attributes can also be used to identify positive or constructive aspects about the corresponding cohort, such as a group's participation in social initiatives (e.g., hunger) or its efforts in advocating for safe and secure programming practices (e.g., responsible AI).

In some instances, the cohort-identification system generates the cohort data by: (i) receiving unstructured data identifying a set of cohort attributes associated with the source cohort and (ii) processing the unstructured data and previous communication data associated with the source digital-communication platform using a cohort-generating machine-learning model to generate the cohort data. The unstructured data items can include information that does not adhere to a predefined format or organized data model, including free-form text, multimedia files, or other non-standardized formats. Examples of unstructured data items can include social media posts, news articles, videos, audio recordings, text streams uploaded by users, and any combinations thereof.

At step 504, the cohort-identification system extracts textual markers and features from the cohort data. The textual markers and features describe one or more characteristics associated with the source cohort. For example, feature extraction from the cohort data can be conducted using NLP techniques, including TF-IDF vectorization to identify relevant keywords and sentiment analysis to determine the characteristics of user interactions associated with the source cohort. In some embodiments, an LLM can be used to extract cohort-specific textual markers, such as key phrases, hashtags, or semantic cues that characterize the group. Alternatively, a user may describe a target cohort, allowing an LLM to drive downstream feature and user discovery, bootstrapping new cohorts.

At step 506, the cohort-identification system accesses filtered communication data from a target digital-communication platform based on the textual markers and features. In some instances, the target digital-communication platform is a different platform from the source digital-communication platform. To access the filtered communication data, the cohort-identification system applies the textual markers and features to select the filtered communication data from other communication data associated with the target digital-communication platform. In some instances, the cohort-identification system can generate one or more queries that include the textual markers and features and execute the one or more queries to access the filtered communication data. For example, SQL or natural-language queries can be dynamically constructed based on the textual markers to filter communication data (e.g., messages, posts, or comments containing specific terms or sentiment patterns) associated with the target digital-communication platform. The retrieved data can then be used to identify primary and secondary accounts of a cohort within the target digital-communication platform.

At step 508, the cohort-identification system generates annotated communication data by annotating a portion of the filtered communication data. To annotate the portion of the filtered communication data, the cohort-identification system associates the portion of the filtered communication data with a set of annotations. The set of annotations is generated by processing the portion of the filtered communication data using an annotation-generating machine-learning model. For example, the annotation-generating machine-learning model can include natural language processing (NLP) algorithms such as entity recognition, sentiment analysis, topic modeling, or intent classification for identifying annotations for the filtered communication data. Stated differently, relevant linguistic and contextual annotations from the filtered communication data can be identified to generate the annotated communication data. The annotated communication data can then be used as training data for training a classification model to identify cohorts in the target digital-communication platform.

At step 510, the cohort-identification system applies a classification model to remaining portions of the filtered communication data to determine a target cohort associated with the target digital-communication platform. The target cohort can include one or more users who share common characteristics or interaction patterns associated with the source cohort. As a result, the cohort data of the source digital-communication platform can be used to identify similar cohorts within the target digital-communication platform. In some instances, steps 502-510 can be iterated to identify similar cohorts in a plurality of digital-communication platforms.

Examples of the classification model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the classification model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

In some instances, the classification model was trained using the annotated communication data. For example, the cohort-identification system identifies one or more primary accounts associated with the target cohort. The one or more primary accounts generate content that conforms to a set of cohort attributes associated with the target cohort. In some instances, the classification model includes a transformer machine-learning model. Process 500 terminates thereafter.

### II. Example Systems

FIG. 6 illustrates a computing system architecture 600, including various components in electrical communication with each other, in accordance with some embodiments. The example computing system architecture 600 illustrated in FIG. 6 includes a computing device 602, which has various components in electrical communication with each other using a connection 606, such as a bus, in accordance with some implementations. The example computing system architecture 600 includes a processing unit 604 that is in electrical communication with various system components, using the connection 606, and including the system memory 614. In some embodiments, the system memory 614 includes read-only memory (ROM), random-access memory (RAM), and other such memory technologies including, but not limited to, those described herein. In some embodiments, the example computing system architecture 600 includes a cache 608 of high-speed memory connected directly with, in close proximity to, or integrated as part of the processor 604. The system architecture 600 can copy data from the memory 614 and/or the storage device 610 to the cache 608 for quick access by the processor 604. In this way, the cache 608 can provide a performance boost that decreases or eliminates processor delays in the processor 604 due to waiting for data. Using modules, methods and services such as those described herein, the processor 604 can be configured to perform various actions. In some embodiments, the cache 608 may include multiple types of cache including, for example, level one (L1) and level two (L2) cache. The memory 614 may be referred to herein as system memory or computer system memory. The memory 614 may include, at various times, elements of an operating system, one or more applications, data associated with the operating system or the one or more applications, or other such data associated with the computing device 602.

Other system memory 614 can be available for use as well. The memory 614 can include multiple different types of memory with different performance characteristics. The processor 604 can include any general purpose processor and one or more hardware or software services, such as service 612 stored in storage device 610, configured to control the processor 604 as well as a special-purpose processor where software instructions are incorporated into the actual processor design. The processor 604 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 604 can be a microprocessor, a microcontroller, a digital signal processor (“DSP”), or a combination of these and/or other types of processors. In some embodiments, the processor 604 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 600, an input device 616 can represent any number of input mechanisms, such as a microphone for speech, a touch-sensitive screen for gesture or graphical input, keyboard, mouse, motion input, pen, and other such input devices. An output device 618 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 600. In some embodiments, the input device 616 and/or the output device 618 can be coupled to the computing device 602 using a remote connection device such as, for example, a communication interface such as the network interface 620 described herein. In such embodiments, the communication interface can govern and manage the input and output received from the attached input device 616 and/or output device 618. As may be contemplated, there is no restriction on operating on any particular hardware arrangement and accordingly the basic features here may easily be substituted for other hardware, software, or firmware arrangements as they are developed.

In some embodiments, the storage device 610 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 610 can include hardware and/or software services such as service 612 that can control or configure the processor 604 to perform one or more functions including, but not limited to, the methods, processes, functions, systems, and services described herein in various embodiments. In some embodiments, the hardware or software services can be implemented as modules. As illustrated in example computing system architecture 600, the storage device 610 can be connected to other parts of the computing device 602 using the system connection 606. In some embodiments, a hardware service or hardware module such as service 612, that performs a function can include a software component stored in a non-transitory computer-readable medium that, in connection with the necessary hardware components, such as the processor 604, connection 606, cache 608, storage device 610, memory 614, input device 616, output device 618, and so forth, can carry out the functions such as those described herein.

The disclosed systems and service of a cohort-identification system (e.g., the cohort-identification system described herein at least in connection with FIG. 1) can be performed using a computing system such as the example computing system illustrated in FIG. 6, using one or more components of the example computing system architecture 600. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for multi-dimensional user cohort classification, expansion, and cross-platform adaptation associated with the cohort-identification system described herein by, for example, executing code using a processor such as processor 604 wherein the code is stored in memory such as memory 614 as described herein. One or more of a user device, a provider server or system, a database system, or other such devices, services, or systems may include some or all of the components of the computing system such as the example computing system illustrated in FIG. 6, using one or more components of the example computing system architecture 600 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 628. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 604 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 614 can be coupled to the processor 604 by, for example, a connector such as connector 606, or a bus. As used herein, a connector or bus such as connector 606 is a communications system that transfers data between components within the computing device 602 and may, in some embodiments, be used to transfer data between computing devices. The connector 606 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 614 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described above, the connector 606 (or bus) can also couple the processor 604 to the storage device 610, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 610. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 606 can also couple the processor 604 to a network interface device such as the network interface 620. The interface can include one or more of a modem or other such network interfaces including, but not limited to those described herein. It will be appreciated that the network interface 620 may be considered to be part of the computing device 602 or may be separate from the computing device 602. The network interface 620 can include one or more of an analog modem, Integrated Services Digital Network (ISDN) modem, cable modem, token ring interface, satellite transmission interface, or other interfaces for coupling a computer system to other computer systems. In some embodiments, the network interface 620 can include one or more input and/or output (I/O) devices. The I/O devices can include, by way of example but not limitation, input devices such as input device 616 and/or output devices such as output device 618. For example, the network interface 620 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 602 can be connected to one or more additional computing devices such as computing device 624 via a network 622 using a connection such as the network interface 620. In such embodiments, the computing device 624 may execute one or more services 626 to perform one or more functions under the control of, or on behalf of, programs and/or services operating on computing device 602. In some embodiments, a computing device such as computing device 624 may include one or more of the types of components as described in connection with computing device 602 including, but not limited to, a processor such as processor 604, a connection such as connection 606, a cache such as cache 608, a storage device such as storage device 610, memory such as memory 614, an input device such as input device 616, and an output device such as output device 618. In such embodiments, the computing device 624 can carry out the functions such as those described herein in connection with computing device 602. In some embodiments, the computing device 602 can be connected to a plurality of computing devices such as computing device 624, each of which may also be connected to a plurality of computing devices such as computing device 624. Such an embodiment may be referred to herein as a distributed computing environment.

The network 622 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 622 can be wired connections, wireless connections, or combinations thereof. Communications via the network 622 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 622, within the computing device 602, within the computing device 624, or within the computing resources provider 628 can include information, which also may be referred to herein as content. The information may include text, graphics, audio, video, haptics, and/or any other information that can be provided to a user of the computing device such as the computing device 602. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 602 and presented to a user of the computing device 602 using forms that are perceptible via sight, sound, smell, taste, touch, or other such mechanisms. In some embodiments, communications over the network 622 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 602 and/or the computing device 624 can be connected to a computing resources provider 628 via the network 622 using a network interface such as those described herein (e.g. network interface 620). In such embodiments, one or more systems (e.g., service 630 and service 632) hosted within the computing resources provider 628 (also referred to herein as within “a computing resources provider environment”) may execute one or more services to perform one or more functions under the control of, or on behalf of, programs and/or services operating on computing device 602 and/or computing device 624. Systems such as service 630 and service 632 may include one or more computing devices such as those described herein to execute computer code to perform the one or more functions under the control of, or on behalf of, programs and/or services operating on computing device 602 and/or computing device 624.

For example, the computing resources provider 628 may provide a service, operating on service 630 to store data for the computing device 602 when, for example, the amount of data that the computing device 602 exceeds the capacity of storage device 610. In another example, the computing resources provider 628 may provide a service to first instantiate a virtual machine (VM) on service 632, use that VM to access the data stored on service 632, perform one or more operations on that data, and provide a result of those one or more operations to the computing device 602. Such operations (e.g., data storage and VM instantiation) may be referred to herein as operating “in the cloud,” “within a cloud computing environment,” or “within a hosted virtual machine environment,” and the computing resources provider 628 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 628 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 630 and service 632 may implement versions of various services (e.g., the service 612 or the service 626) on behalf of, or under the control of, computing device 602 and/or computing device 624. Such implemented versions of various services may involve one or more virtualization techniques so that, for example, it may appear to a user of computing device 602 that the service 612 is executing on the computing device 602 when the service is executing on, for example, service 630. As may also be contemplated, the various services operating within the computing resources provider 628 environment may be distributed among various systems within the environment as well as partially distributed onto computing device 624 and/or computing device 602.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 602) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 300 of FIG. 3, the example process 500 of FIG. 5). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 602.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method of generating a set of cohorts associated with a digital-communication platform, the method comprising:
accessing communication data from the digital-communication platform, wherein the communication data identifies a plurality of accounts;
determining a set of primary accounts from the plurality of accounts, wherein a primary account of the set of primary accounts is determined to generate content that conforms to a set of cohort attributes, and wherein the set of cohort attributes are associated with one or more characteristics of a particular cohort of the set of cohorts;
for each primary account of the set of primary accounts:
identifying one or more secondary accounts that performed one or more operations that interact with the content generated by the primary account; and
associating the one or more secondary accounts with the primary account to generate a cohort of the set of cohorts; and
refining each of the set of cohorts by validating the one or more secondary accounts associated with a corresponding primary account.

2. The computer-implemented method of claim 1, wherein the communication data includes account profiles associated with the plurality of accounts, a plurality of messages generated by the plurality of accounts, and network metadata associated with the digital-communication platform.

3. The computer-implemented method of claim 1, wherein identifying the one or more secondary accounts includes:
for an account of the plurality of accounts:
generating an exposure score for the account, wherein the exposure score represents an estimated degree of interactions that conform to the set of cohort attributes, wherein the exposure score is generated by processing a portion of the communication data using a machine-learning model, and wherein the portion of the communication data is associated with the account;
determining that the exposure score exceeds a threshold value; and
identifying the account as a secondary account of the one or more secondary accounts.

4. The computer-implemented method of claim 1, wherein validating the one or more secondary accounts includes determining whether the one or more secondary accounts generated content that conforms to the set of cohort attributes.

5. The computer-implemented method of claim 1, wherein the set of cohort attributes is generated by processing the communication data using a machine-learning model.

6. The computer-implemented method of claim 1, wherein the primary account is determined further based on a number of accounts that interacted with the primary account exceeding a threshold value.

7. The computer-implemented method of claim 1, wherein the primary account is determined further based on a number of messages corresponding to the content.

8. A system comprising:
one or more processors; and
memory storing thereon instructions that, as a result of being executed by the one or more processors, cause the system to perform operations comprising:
accessing communication data from a digital-communication platform, wherein the communication data identifies a plurality of accounts;
determining a set of primary accounts from the plurality of accounts, wherein a primary account of the set of primary accounts is determined to generate content that conforms to a set of cohort attributes, and wherein the set of cohort attributes are associated with one or more characteristics of a particular cohort of a set of cohorts;
for each primary account of the set of primary accounts:
identifying one or more secondary accounts that performed one or more operations that interact with the content generated by the primary account; and
associating the one or more secondary accounts with the primary account to generate a cohort of the set of cohorts; and
refining each of the set of cohorts by validating the one or more secondary accounts associated with a corresponding primary account.

9. The system of claim 8, wherein the communication data includes account profiles associated with the plurality of accounts, a plurality of messages generated by the plurality of accounts, and network metadata associated with the digital-communication platform.

10. The system of claim 8, wherein identifying the one or more secondary accounts includes:
for an account of the plurality of accounts:
generating an exposure score for the account, wherein the exposure score represents an estimated degree of interactions that conform to the set of cohort attributes, wherein the exposure score is generated by processing a portion of the communication data using a machine-learning model, and wherein the portion of the communication data is associated with the account;
determining that the exposure score exceeds a threshold value; and
identifying the account as a secondary account of the one or more secondary accounts.

11. The system of claim 8, wherein validating the one or more secondary accounts includes determining whether the one or more secondary accounts generated content that conforms to the set of cohort attributes.

12. The system of claim 8, wherein the set of cohort attributes is generated by processing the communication data using a machine-learning model.

13. The system of claim 8, wherein the primary account is determined further based on a number of accounts that interacted with the primary account exceeding a threshold value.

14. The system of claim 8, wherein the primary account is determined further based on a number of messages corresponding to the content.

15. A non-transitory, computer-readable storage medium storing thereon executable instructions that, as a result of being executed by one or more processors of a computer system, cause the computer system to perform operations comprising:
accessing communication data from a digital-communication platform, wherein the communication data identifies a plurality of accounts;
determining a set of primary accounts from the plurality of accounts, wherein a primary account of the set of primary accounts is determined to generate content that conforms to a set of cohort attributes, and wherein the set of cohort attributes are associated with one or more characteristics of a particular cohort of a set of cohorts;
for each primary account of the set of primary accounts:
identifying one or more secondary accounts that performed one or more operations that interact with the content generated by the primary account; and
associating the one or more secondary accounts with the primary account to generate a cohort of the set of cohorts; and
refining each of the set of cohorts by validating the one or more secondary accounts associated with a corresponding primary account.

16. The non-transitory, computer-readable storage medium of claim 15, wherein the communication data includes account profiles associated with the plurality of accounts, a plurality of messages generated by the plurality of accounts, and network metadata associated with the digital-communication platform.

17. The non-transitory, computer-readable storage medium of claim 15, wherein identifying the one or more secondary accounts includes:
for an account of the plurality of accounts:
generating an exposure score for the account, wherein the exposure score represents an estimated degree of interactions that conform to the set of cohort attributes, wherein the exposure score is generated by processing a portion of the communication data using a machine-learning model, and wherein the portion of the communication data is associated with the account;
determining that the exposure score exceeds a threshold value; and
identifying the account as a secondary account of the one or more secondary accounts.

18. The non-transitory, computer-readable storage medium of claim 15, wherein validating the one or more secondary accounts includes determining whether the one or more secondary accounts generated content that conforms to the set of cohort attributes.

19. The non-transitory, computer-readable storage medium of claim 15, wherein the set of cohort attributes is generated by processing the communication data using a machine-learning model.

20. The non-transitory, computer-readable storage medium of claim 15, wherein the primary account is determined further based on a number of accounts that interacted with the primary account exceeding a threshold value, or a number of messages corresponding to the content.
